(19) United States
(12) Patent Application Publication
(10) Pub. No.: US 2005/0035200 A1
(43) Pub. Date: Feb. 17, 2005

(54) Secure smartcard sleeve

(76) Inventor: Colin Hendrick, Brooklyn, NY (US)

Correspondence Address: Glen E. Books, Esq.;Lowenstein Sandler, P.C., 65 Livingston Avenue, Roseland, NJ, 07068, US

(21) Appl. No.: 10/638,921

(22) Filed: Aug. 11, 2003

(51) Int. Cl. G06K 7/06

(52) U.S. Cl. 235/441

(57) ABSTRACT

A portable personal interface for a smartcard comprises a receptacle for receiving the smartcard to facilitate smartcard based transactions comprising one or more sensors of a user's features and a microcomputer for confirming the user's identity. A memory holds stored data representative of features of an authentic user of the card. A sensor on the interface collects data representative of features of the current user of the card, and a microcomputer compares the stored data with the sensed data to determine whether the current user is the authentic user. The features of the authentic user of the card can be stored on the card or in the memory of the interface, in which case the card comprises an identification code that correlates to specific stored data representative of one or more user's features. In the preferred embodiment, the portable personal interface comprises a smartcard sleeve.

### FIELD OF THE INVENTION

This invention relates to smartcard interfaces and, in particular to personal, portable interfaces by which a user and only a user can securely direct money transfers, obtain access to restricted locations or conduct other secured transactions using a smartcard. The interface, preferably in the form of a smartcard sleeve, confirms the correct user identity before permitting card-based transactions.

### BACKGROUND OF THE INVENTION

Credit cards are an essential part of business and personal commerce. Credit card fraud has been a problem from the outset. Early attempts at fraud prevention involved authenticating the card itself. For example, issuing companies and banks printed logos and names on the card. Later, holograms were added to identify legitimate cards. User verification was largely limited to comparing a signature on the card to a signature offered by a user at time of purchase. This mode of authentication is subjective, requires a live, in-person transaction, and can be easily evaded. Similar identification cards used to control access to restricted areas suffer similar security weaknesses.

More recently, smartcards have been introduced that incorporate a microcomputer on the face of a credit card or secure access card. FIG. 1 shows a typical smartcard 10. Smartcards retain many of the original credit card security features, including a hologram 17 and a logo 12 which can include a name. The name of the issuing bank or company is also usually printed on the face (not shown). Charges are billed to the credit card account number 13. Further information includes card issue date 14 and an expiration date 16. FIG. 2 shows the rear of the card including signature panel 22, a further verification number 23 and the magnetic stripe from which a transaction reader can derive the account number.

The distinguishing feature of the smartcard is a microcomputer 11. Nonvolatile memory on the card can hold basic user information, including verification information that can be read by a suitable smartcard reader. The lines in the metal pattern overlying the microcomputer chip define electrical contacts that provide data connections and power to the microcomputer. Smartcard credit cards have been issued in modest numbers by some institutions. But to date, few merchants make use of the smart features.

The credit card format has also found use in security access control. Door and building access are the most common uses. Generally card readers read the magnetic stripe on the card and grant access based on recognized account numbers or user identification (ID) numbers. In very high security areas a door access system might employ an eye scanner to authorize entry by a particular individual. Here, the sensor and authentication equipment is part of the fixed permanent assembly at the entry point.

It has further been suggested that cards might add additional security features for user authentication. For example it has been suggested that a card might include an on-board fingerprint sensor for user authentication. FIG. 3 shows such a card with fingerprint sensor 31 integral to the card surface. Such a card, while offering improved user authentication, is still relatively limited in usefulness. And, the addition of the sensor greatly increases the expense of the single card.

Accordingly it can be seen that there is a need for a system that can verify correct user identity in card-based transactions, especially a system that is portable and inexpensive.

### SUMMARY OF THE INVENTION

A portable personal interface for a smartcard comprises a receptacle for receiving the smartcard to facilitate smartcard based transactions comprising one or more sensors of a user's features and a microcomputer for confirming the user's identity. The receptacle has electrical contacts for communicating with the smartcard. A memory holds stored data representative of features of an authentic user of the card. A sensor on the interface collects data representative of features of the current user of the card, and a microcomputer compares the stored data with the sensed data to determine whether the current user is the authentic user. The features of the authentic user of the card can be stored on the card or in the memory of the interface, in which case the card comprises an identification code that correlates to specific stored data representative of one or more user's features. In the preferred embodiment, the portable personal interface comprises a smartcard sleeve.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 shows a smartcard front face according to the prior art;

FIG. 2 shows a smartcard rear face according to the prior art;

FIG. 3 shows a smartcard front face with a fingerprint sensor;

FIG. 4 shows one embodiment of inventive smartcard sleeve having several optional components;

FIG. 5 shows a cut away view of one surface of one embodiment of the secure smartcard sleeve;

FIG. 6 shows a block diagram of one embodiment of the secure smartcard sleeve;

FIG. 7 shows an optional microphone coupled to the sleeve microcomputer;

FIG. 8 shows an optional CCD camera coupled to the sleeve microcomputer;

FIG. 9 is a block diagram showing use of the secure smartcard sleeve for physical security access;

FIG. 10 is a block diagram showing use of a secure smartcard sleeve for secure access to a computer; and

FIG. 11 is a block diagram showing use of a secure smartcard sleeve as a “wallet” for financial transactions.

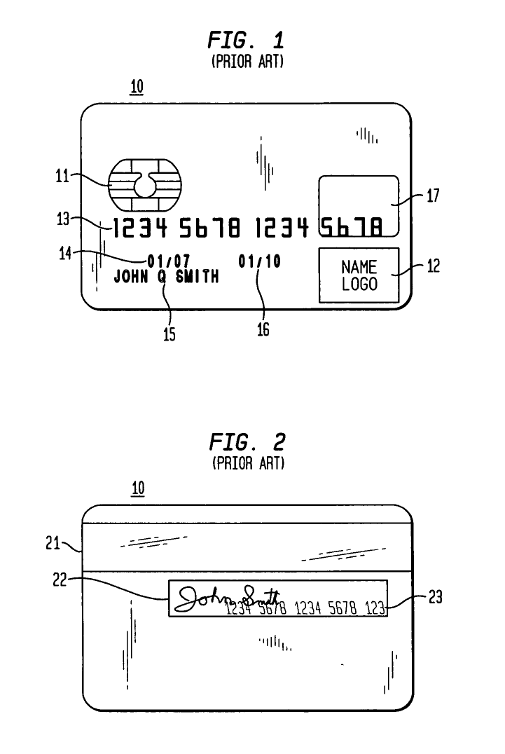

It is to be understood that the drawings are for the purpose of illustrating the concepts of the invention are not to scale.

### DETAILED DESCRIPTION

This description is divided into several parts. In Part I we describe general features of a secure smartcard reader, Part II we discuss security applications for the sleeve, and financial applications are presented in Part III.

I. General Features of the Secure Smartcard Sleeve

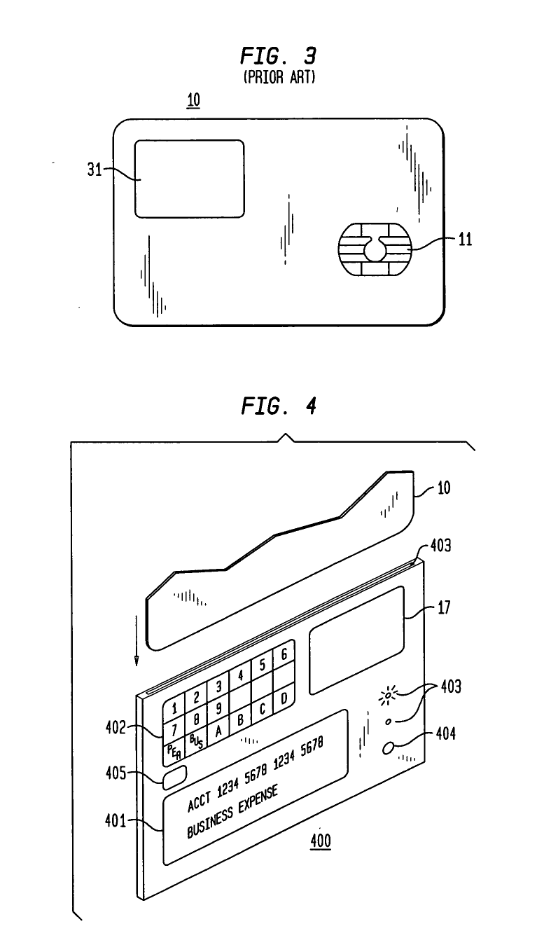

FIG. 4 shows one embodiment of a secure smartcard sleeve according to the invention. Smartcard 10 plugs into secure sleeve 400, typically by manual insertion. On insertion the smartcard establishes communication with sleeve 400 as later described in this section. No further actions or transactions with the smartcard can occur until the secure sleeve positively establishes the user's identity through application of the user's finger to fingerprint sensor 17. Most typically, a human thumbprint is used. Other fingers can be used as well. Finger print verification can optionally be reported by audible tone (speaker not shown in FIG. 4), or by one or more LED indicators 403.

Once user identity has been established by fingerprint verification, actions or transactions can be accomplished without further user intervention, or by user instructions entered by button or soft key 405, or by keypad 402. Prompts can be generated by optional LCD screen 401. LCD screen 401 can also generate labels for one or more soft keys 405 when the keys are situated near the screen 401.

Secure sleeve 400 can then interact with an intended device in one of several ways. In some applications, the sleeve writes new information to smartcard 10. In another application, the sleeve communicates with a security device, such as a door lock, by one of several communications options, including radio, such as WiFi (as standard 802.11), radio signal by internal wire antenna (not shown in FIG. 4), or by infra-red, as by IR emitter 404, such as an IR LED.

Additionally it can be highly advantageous for the secure sleeve to communicate with a personal computer (PC). A PC link can be used to transmit smartcard information to and from the pc or another computer on a network, such as a local network or the Internet. The PC connection can also establish a secure user PC logon. Or the connection can be used to upload or download data held in memory in smartcard 10 or in sleeve 400. The connection between a PC and sleeve 400 can be established by a universal serial port (USB) connection (not shown in FIG. 4), by IR, or the RF antenna.

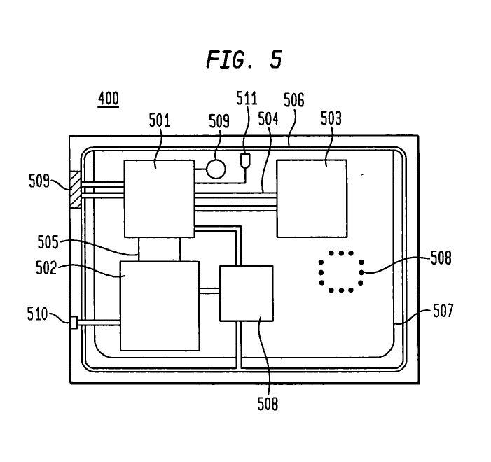

One embodiment of a cutaway view of one surface of sleeve 400 is shown in FIG. 5. Typically this is the opposite surface from the surface housing the controls and displays. It is understood, however that the components described here can be located in any convenient portion of sleeve 400, including internally in the walls of the sleeve, or on any external surface of the sleeve. In the best mode, all components, except for those exposed for user interaction, communications, or transmission of light, are contained within the walls of sleeve 400.

Card guide 507 guides the smartcard into sleeve 400 for proper smartcard alignment. Alignment, while not critical, can be made to sufficient accuracy such that terminals 508, which are exposed on the inside surface of sleeve 400 contact the hard wired communication connections to the microcomputer on smartcard 10, as well as to power smartcard 10. Alternatively sleeve 400 can communicate with a smartcard containing an antenna and a communications system compatible with sleeve 400 by radio frequency (RF) such as by antenna 506. FIG. 5 shows microcomputer 501 coupled to flash memory 503 by data and control bus 504. Flash memory 503 is a very thin semiconductor memory device suitable for embedding in the walls of sleeve 400. 1 gigabyte or more of memory can be achieved using existing flash memory technology.

Ultra thin battery 502 powers the microcomputer, flash memory and all other devices in sleeve 400. Battery 502 can be recharged as needed by power applied to the power connector 510. In another embodiment, a charging device can make contact with sleeve 400 by use of a smartcard charger connector with the dimensions of smartcard 10.

RF device 508 is attached to antenna 506 for communications. Typically device 508 is a transmitter for sending authorization codes to security devices (such as door locks). RF device 508 can also be a transceiver, allowing two way communications with sleeve 400 via antenna 506. Or, RF device can be a WiFi circuit to enable WiFi data communications with PCs or networks via a wireless standard such as 802.11(b).

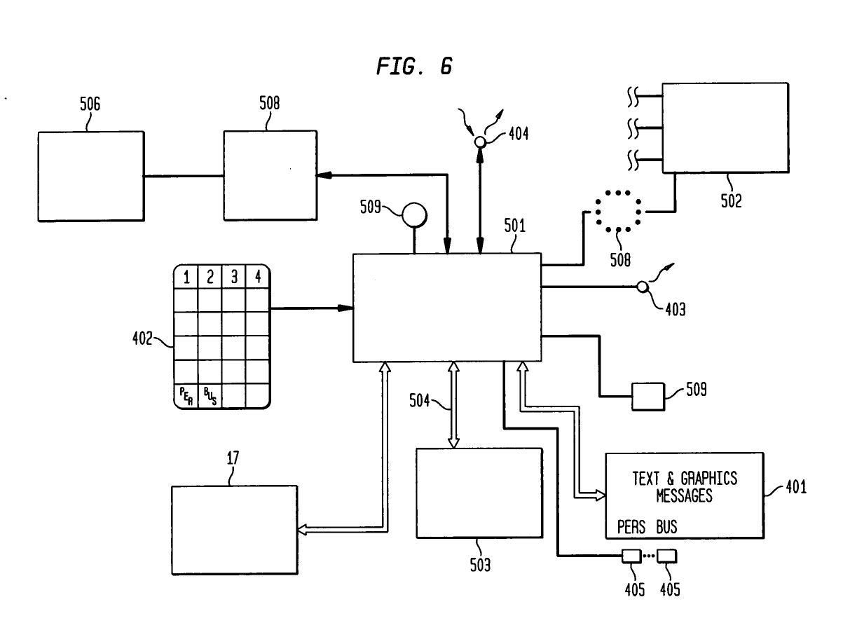

FIG. 6 shows a block diagram of one embodiment of secure smartcard sleeve 400. Battery 502 powers all sleeve devices requiring power. Microcomputer 501 controls the sleeve's devices and performs processing functions. Finger print sensor 17 generates a data pattern representing an individuals finger print for identification purposes. Such devices and algorithms are known, see for example U.S. Pat. No. 5,623,552, “Self-authenticating Identification Card with Fingerprint Identification”, to Lane, which is incorporated by reference herein. It is understood that a sample pattern must be initially obtained from the individual for reference purposes. The reference fingerprint can be stored on flash memory 503 connected by data bus 504 to microcomputer 501. The person's finger print is then read by finger print sensor 17 each time an identity check is required and compared to the reference data by programmed microcomputer 501. This can be done by an apparatus with a finger print sensor that is external to the sleeve and then transmitted to the flash memory in the sleeve by one of the previously discussed methods of communications. Alternatively, the sleeve's finger print sensor 17 can be used to store the image of the individual. Security issues have been addressed regarding protection from an illicit recording of an unauthorized individual's fingerprint. For example an authorization code can be required to write, or to overwrite a reference finger print data.

In another embodiment of the invention, sleeves can be manufactured with the memory for the finger print image being one time programmable OTP memory. In this embodiment the OTP memory (not shown), not the re-writable flash memory can save the finger print data. Once written, an OTP card can only be used to identify the intended individual. The reference fingerprint cannot be changed. In this embodiment, after that individual no longer needs it, or is no longer authorized to use it, the sleeve cannot be reused and would be destroyed.

Keypad 402 and or soft keys 405 (not shown in FIG. 6), can be read by microcomputer 501 as user inputs. User readable output devices include LCD display 401 and one or more LEDs 403. In another embodiment (not shown), LCD 401 can include touch sensitive regions so that it can function as a user entry keypad as well as a display. Some of the functions of these keys and output devices will be described in parts II and III on applications of the secure smartcard sleeve.

Secure smartcard sleeve 400 can communicate with the smartcard via contact pins 508. Sleeve 400 can power smartcard 400 via the same contacts. In another embodiment of the invention, sleeve 400 can communicate with the smartcard via RF antenna 506 through transceiver 508. Here the smartcard can be powered via contacts 508.

Communications with devices other than smartcard 10, such as PCs or security devices, for which the sleeve can provide access identification, can be done in several different modes. Generally communications with PCs can be by USB port 509, or by IR light connection via optional IR transmitter or transceiver 403. In another embodiment, communications between the sleeve and PC or other device can be established via RF transmitter or transceiver 508 through RF antenna 506. Other workable, but less convenient modes, include acoustic coupling, and standard parallel or serial ports other than USB.

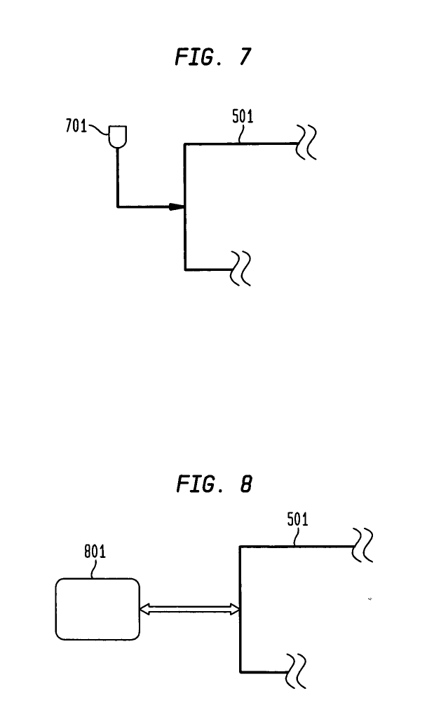

Optional speaker device 509 can give audio feedback such as tones when user entry keys 402 or 405 are pressed, or tones or sounds when actions are taken (such as door access granted). Optional microphone (FIG. 7, 701) can allow for voice commands or voice recognition. Voice recognition can be used in addition to, or in place of fingerprint sensor 17 for identity verification. In this embodiment microcomputer 501 can perform the voice print recognition by using techniques in digital signal processing. In another embodiment as shown in FIG. 8, charge coupled device (CCD) 801 can be used to view a human body feature, such as the human eye, for personal identification. In yet another embodiment, CCD 801 can be used to do facial recognition. Microcomputer 501 can perform the image analysis for positive identification.

In some cases authorizations, or credit card numbers, or credit card generating systems may depend on time of day and date. In such cases the sleeve can also incorporate an electronic clock. While it would be practical, but less convenient to further add electronics that receive national timing signals (as WWVB) to align the clock, such a clock can also be easily updated by standard access to a local computer system by any of the communications methods discussed.

It is further understood that that the features of the authentic user of the card can be stored on the card or in the memory of the interface, in which case the card comprises an identification code that correlates to specific stored data representative of one or more user's features. In this embodiment, a smartcard can be authenticated by another's card interface. For example, the smartcard sleeves belonging to family members can be keyed by a code on the smartcard to accept authentication from two or more authorized users in the family.

II. Secure Smartcard Sleeve Security Applications

The secure smartcard sleeve has many uses for applications required on the spot identification (ID) checks. These range from building access security to personal security challenges made by police or guards to computer access.

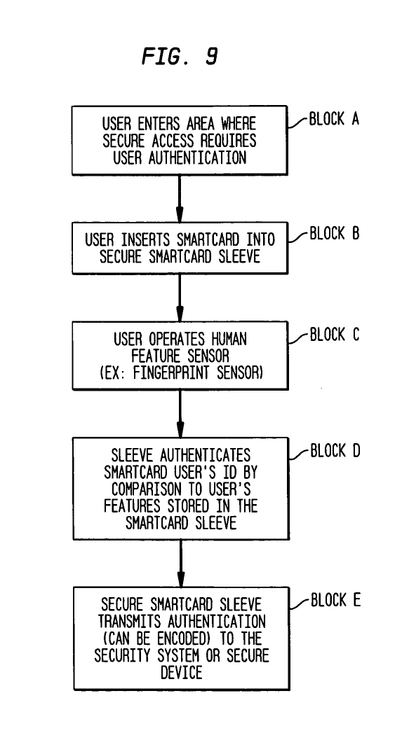

FIG. 9 is a block diagram illustrating the use os a secure smartcard sleeve for physical access. In a secure building setting (Block A), a user can insert their smartcard into the sleeve (Block B) in order to verify their identity. The secure sleeve can be used to compare a user's human feature (Block C), such as a fingerprint where the sleeve comprises a fingerprint reader, to authenticate the user's identity. On successful comparison with the reference feature (Block D), the sleeve can communicate with the building security system, or a smart building door lock, and on sending a secure code (Block E), granting access through the now unlocked door. In this case the sleeve can send a cryptographic code, or a prearranged access code, so that an individual without a secure smart sleeve would not be able to simply generate an “open code” to defeat the security system using a transmitter and code generator “hack”. Communications from the sleeve to the building security system can be for example by RF, IR, or less desirably, by cable.

Once inside the secure building, a guard can prompt an individual to produce a smartcard. In this case the individual can also produce a secure smart sleeve, and perform the ID check, or the guard can produce an independently held secure smartcard sleeve. In the embodiment where the guard produces an independent sleeve, the guard's sleeve can be pre-loaded with all finger print reference data for all individuals authorized access to the building. In yet another embodiment, the guard's sleeve can communicate via any of the heretofore communications methods with an intranet or the Internet to access a particular individual's finger print data file. In the case of a highly secure government building, the guard's sleeve can further access government data files on an intranet or by the Internet, as to the FBI's fingerprint database to identify the individual. In this case, data regarding the individual can be displayed on the LCD screen.

In another embodiment of the invention, an individual can gain access to secure elevators in a building by performing an ID check, as by fingerprint, at the elevator entrance. The secure smartcard sleeve communicates a positive ID check to the building elevator system. On gaining access to the elevator, the individual may only be permitted to select certain authorized floors based on either the authorization code sent by the sleeve to the elevator, or the building security systems reaction to the ID code from that sleeve. An LED or other LCD screen indication can alert the holder of the sleeve to the positive ID and one or more authorized floors.

On exiting an elevator, the sleeve can be used to access the secure doors at a given floor's offices by ID check and to communicate with the building security system, or a specific smart lock, as heretofore described.

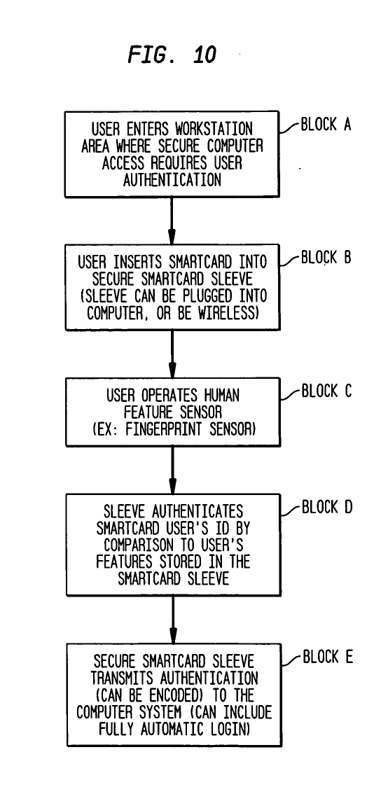

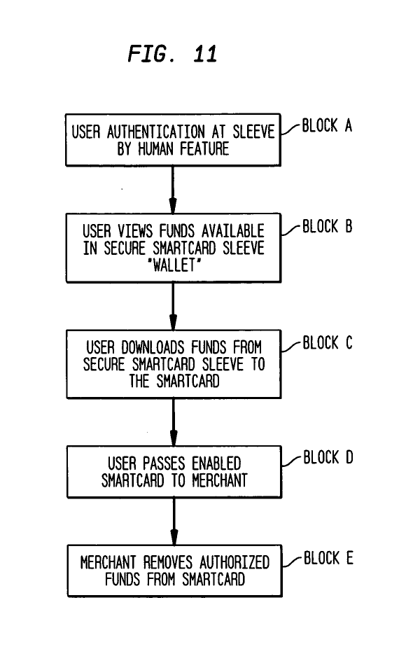

On entering a computer workstation area (Block A), as shown in FIG. 10, computer access can be gained by ID check. The user enters a user smartcard into a secure smartcard reader (Block B). The sleeve can be plugged into the computer by a cable, as a USB cable, or connect to the computer by a wireless technology, as by RF connection, by any of the already discussed communications modes (Block B). The user then operates some human feature sensor (Block C), such as a fingerprint sensor in one embodiment of the invention, to authenticate the user's identity (Block D). The sleeve than transmits the user authentication data to the computer and where there is a positive authentication, the computer can grant access to the user (Block E). In one embodiment of the invention, the login process can be completely automatic, including entry of user name and password. In the event of a negative authentication (no match with the stored feature), the sleeve can still transmit the sleeve's user code to the computer for logging unsuccessful authentication attempts. Once in communications with the computer, the computer can also perform a “hot sync” function passing updated information to and from the user's sleeve.

In an even more secure embodiment, useful for any of the discussed access by ID configurations, further user input can be required. For example, the employee can be asked to enter an additional personal identification code (PIN), following a successful ID check by fingerprint. Or, in an embodiment with a microphone for voice recognition, or an optical scanner, such as a CCD array for human eye scanning, two or more verification actions can be required for access or to enable a secure action. It is further contemplated that chemical sensors, such as breath sensors can be used for primary or secondary user verification. Similarly alcohol breath sensors could be used to provide additional go/no-go authorization based on blood alcohol content regardless of the identity authentication. Such access limitations could be useful where authentication is being requested for access to operate vehicles such as motorized vehicles, including armored vehicles and tanks, boats and ships, or aircraft.

III. Secure Smartcard Sleeve Financial Applications

The secure smart card sleeve has many uses for financial applications. In the simplest embodiment, a user can use a smartcard to pay a bill, and then after the transaction is processed register the transaction to a specific account, such as business or personal, for record keeping.

Where a merchant's credit card reader functions with the smart card interface chip as opposed to the magnetic stripe alone, the secure smartcard sleeve can serve to activate an otherwise unusable or unreadable smartcard for that particular transaction.

In one embodiment, the sleeve can also function as a secure “wallet” as shown in FIG. 11. Funds can be loaded into the sleeve for use thought a smartcard. Here, the smartcard can receive and transmit loaded funds from the sleeve. The human feature sensor can be used to authenticate the user before allowing funds transfers to or from a smartcard as shown in Block A. The LCD display on the sleeve can show funds (as held in the sleeve wallet) available for disbursements and funds loaded to the smartcard, as ready to be spent (Block B). The sleeve memory can hold the funds in the wallet, and transfer funds as needed to the smartcard (Block C). The smartcard can then be used to make the actual disbursements to merchants for effecting money transfers, typically to make purchases (Blocks D, E). Where currency conversions are required, the sleeve's microcontroller can perform this function and display the exchange rates and amounts of funds dispersed in one or several currencies. The currency rates as held in the sleeve can be updated from a server or PC by any of the communications methods previously discussed.

In another embodiment, the sleeve can be used with a “blank” smartcard. Here, the sleeve loads the smartcard with a given account representing one of many user accounts, such as that individual's credit card account numbers. This embodiment can be useful where, for example, one account is used for personal expenditures, and another is used for business expenditures. In this system, the merchant's credit card reader reads from the smartcard contacts and not from the magnetic stripe. In a further use of the “blank” smartcard application, the user can generate an authorized credit card number for one time use. Such numbers can be downloaded to the sleeve, or the sleeve can calculate the numbers from a predetermined equation supplied the sleeve from a terminal and authorized for use by that individual.

The combination of the keypad, LCD screen, and microcomputer also allow the sleeve to perform helpful functions such as calculations involving tips. Where a merchant can accept a smartcard by reading the smart chip on the card as opposed to the magnetic stripe, a diner can make use of this type of functionality. For example, on entering the amount of a dinner tab, the sleeve could prompt the user to add an additional value for the tip. This can be done by the user entering the percentage on the keypad, or by the LCD, for example, offering options of 10%, 13%, 15%, 17%, 20% in the form of LCD generated labels over soft keys thus defined for that operation.

It is understood that the above-described embodiments are illustrative of only a few of the many possible specific embodiments, which can represent applications of the invention. Numerous and varied other arrangements can be made by those skilled in the art without departing from the spirit and scope of the invention.

1. A portable personal interface for a smartcard comprising:
a receptacle for receiving the smartcard, the receptacle having electrical contacts for communicating with the smartcard;
a memory to hold stored data representative of features of the authentic user of the card;
a sensor for collecting data representative of features of the current user of the card; and
a microcomputer to compare the stored data with the sensed data to determine whether the current user is the authentic user.

2. The interface of claim 1 wherein the interface comprises a smartcard sleeve.

3. The interface of claim 1 wherein the sensor comprises a sensor selected from the group consisting of fingerprint sensor, CCD camera, chemical sensor, and microphone.

4. The interface of claim 1 wherein the smartcard is a credit card.

5. The interface of claim 1 wherein the smartcard is an identification card.

6. The interface of claim 1 wherein the smartcard is configured by the interface.

7. A secure smartcard sleeve for user authentication comprising:
a receptacle including two major surfaces with an opening formed between the two surfaces to accept the smartcard into the sleeve;
a plurality of contacts exposed on the inside of the receptacle to make electrical contact with the smartcard;
flash memory coupled to the microcomputer to hold user feature data;
a user feature sensor mounted on the outside of the receptacle and coupled to the microcomputer to authenticate a user;
a programmed microcomputer mounted on or within one of the surfaces to control the secure smartcard sleeve, and to compare a user's sensed feature to a stored user feature, wherein a positive comparison enables the smartcard, or communicates authorization to an outside device or process based on the positive comparison; and
a battery mounted within the one of the surfaces to power the microcomputer, flash memory, user feature sensor, and indicator

8. The secure smartcard sleeve of claim 7 wherein the user feature sensor is a finger print sensor mounted on the outside of the receptacle and coupled to the microcomputer to authenticate a user.

9. The secure smartcard sleeve of claim 7 wherein the user feature sensor is a camera sensor mounted on the outside of the receptacle and coupled to the microcomputer to authenticate a user.

10. The secure smartcard sleeve of claim 9 wherein the camera is a CCD camera.

11. The secure smartcard sleeve of claim 7 wherein the user feature sensor is a chemical sensor mounted on the outside of the receptacle and coupled to the microcomputer to authenticate a user.

12. The secure smartcard sleeve of claim 7 further comprising a visual indicator to indicate a positive match.

13. The secure smartcard sleeve of claim 7 further comprising an audio indicator to indicate a positive match.

14. The secure smartcard sleeve of claim 7 further comprising an LCD screen to communicate information to the user.

15. The secure smartcard sleeve of claim 14 wherein the LCD screen displays labels in the vicinity of one or more smart keys to show the function of the one or more keys.

16. The secure smartcard sleeve of claim 14 wherein the LCD screen had touch sensitive areas and additionally serves as a key pad for user input.

17. The secure smartcard sleeve of claim 7 further comprising a radio frequency (RF) section and an antenna to transmit a signal to the outside device.

18. The secure smartcard sleeve of claim 17 wherein the signal is a secure code.

19. The secure smartcard sleeve of claim 17 wherein the outside device is a door lock.

20. The secure smartcard sleeve of claim 17 wherein the outside device is a building security system.

21. The secure smartcard sleeve of claim 7 further comprising one or more keys mounted on the outside of one of the surfaces of the receptacle and coupled to the microcomputer for user input.

22. The secure smartcard sleeve of claim 7 further comprising a microphone on the outside of one of the surfaces of the receptacle and coupled to the microcomputer for user input.

23. The secure smartcard sleeve of claim 7 further comprising a video camera on the outside of one of the surfaces of the receptacle and coupled to the microcomputer for user input.

24. The secure smartcard sleeve of claim 7 further comprising a universal serial port (USB) connection to another computer.

25. A method of using a secure smartcard sleeve to authenticate the user of a smartcard comprising:
inserting a smartcard into the secure smartcard sleeve;
sensing a feature of the user;
comparing the sensed feature to a stored image of the user's feature;
authenticating the user; and
acting on the authentication.

26. The method of claim 25 further comprising entering a personal identification (PIN) code for additional verification of identity.

27. The method of claim 25 further comprising indicating, visually or aurally, the status of the verification of identity.

28. The method of claim 25 wherein acting comprises transmitting a positive user authentication to an outside device.

29. The method of claim 28 further comprising permitting access based on reception of the positive user authentication.

30. The method of claim 25 wherein acting comprises enabling the smartcard to make a purchase.

31. The method of claim 25 wherein acting comprises permitting the user to log into a computer system.

32. The method of claim 25 wherein acting comprises logging the user into a user account automatically based on the authentication.

33. A method of using a secure smartcard sleeve wallet to authenticate the user of a smartcard for transferring funds to and from a smartcard comprising:
inserting a smartcard into the secure smartcard sleeve;
sensing a feature of the user;
comparing the sensed feature to a stored image of the user's feature;
authenticating the user; and
enabling a transfer of funds between the sleeve wallet and the smartcard.

34. The method of claim 33 wherein sensing a feature, comprises sensing a fingerprint.

35. The method of claim 33 further comprising the step of displaying the funds on an LCD display.

36. A method of doing business comprising:
providing a smartcard;
providing a secure smartcard sleeve;
storing funds in the secure smartcard sleeve from a funds server;
authenticating a user with the secure smartcard sleeve by a user feature;
dispensing funds to the smartcard using the secure smartcard sleeve; and
expending the funds using the smartcard.
